(19) United States
(12) Patent Application Publication
(10) Pub. No.: US 2022/0045797 A1
(43) Pub. Date: Feb. 10, 2022

(54) METHOD FOR ROBUSTLY TRANSMITTING DIGITIZED SIGNAL SAMPLES IN AN RF COMMUNICATION SYSTEM

(71) Applicant: THALES, Courbevoie (FR)

(72) Inventors: Fabrice ARNAL, TOULOUSE (FR); Nicolas VAN WAMBEKE, TOULOUSE (FR); Pierre ROGNANT, TOULOUSE (FR)

(21) Appl. No.: 17/393,428

(22) Filed: Aug. 4, 2021

(30) Foreign Application Priority Data
Aug. 6, 2020 (FR) 2008323

(51) Int. Cl. H04L 1/18; H04L 1/16

(52) U.S. Cl. CPC H04L 1/189; H04L 1/1628; H04L 1/1664

(57) ABSTRACT

A method for transmitting data in a radiofrequency (RF) communication system, includes at least one piece of equipment, referred to as the BBU, configured to generate I/Q samples from data to be sent, and to extract a payload from I/Q samples, a plurality of pieces of equipment, referred to as RRH, configured to generate and transmit an RF analogue signal on the basis of I/Q samples, and to generate I/Q samples from a received RF signal, digital communication links between BBU and RRH, each BBU being configured to transmit/receive data through one of the RRH, the I/Q samples exchange being organized in the form of sample packets marked by a sequence identifier, BBU and RRH implementing a mechanism for acknowledgement of the exchanged packets, and to change RRH depending on the state of the acknowledgements. The communication system and equipment implementing the method are also provided.

### CROSS-REFERENCE TO RELATED APPLICATIONS

This application claims priority to foreign French patent application No. FR 2008323, filed on Aug. 6, 2020, the disclosure of which is incorporated by reference in its entirety.

### FIELD OF THE INVENTION

The invention relates to the field of radio-frequency (RF) telecommunications, and more particularly relates to a method for transmitting samples of a digitized signal between a piece of equipment generating samples of a signal to be sent and the piece of equipment tasked with the transmission thereof.

### BACKGROUND

The invention is applicable when the piece of equipment tasked with generating the samples of a signal to be sent is distinct or even remote from the piece of equipment tasked with its actual transmission. This is for example the case for satellite communications in frequency bands in which there is a high risk of attenuation of the signal (for example the Ka band, which is sensitive to meteorological conditions) as the site of transmission of the signal may be required to change in order to overcome transmission difficulties, or when a piece of equipment operating in baseband centralizes the transmissions of one or more transmitting stations, such as is increasingly the case for example in the networks of mobile communication operators.

FIG. 1 for example illustrates the principle of generation and transmission of an RF signal in a satellite communication network 100 according to the prior art.

In the uplink direction (i.e. to transmit data via the BBU in the communication network through the satellite), a piece of equipment 101, commonly designated by the acronym BBU (which stands for Base Band Unit) is tasked with generating the signals to be transmitted in the form of a sequence of in-phase and quadrature samples modulated in baseband, which are denoted I/Q samples. The information to be transmitted may be generated directly by the BBU 101, or be retrieved from a third-party piece of equipment through a network 102 of any type positioned upstream of the BBU. The BBU carries out the operations of coding and of modulating in baseband the information to be transmitted. The I/Q samples modulated by the BBU 101 are transmitted to a piece of equipment 103, designated by the acronym RRH (standing for Remote Radio Head) or RRU (standing for Remote Radio Unit), by way of a linking system for digital data, such as an Ethernet network, an IP network, etc., employing any type of physical medium (copper, coaxial cables, radio links, optical fibre on a dedicated link, etc.) that meets the constraints as regards the throughput of the flows to be transported. The RRH receives as inputs the digital I/Q samples sent by the BBU, and converts them into a radiofrequency analogue signal on a carrier frequency. The RRH sends this analogue RF signal over the air to a geostationary satellite 105 or to a constellation of satellites in low or medium Earth orbit, through a satcom antenna 104. The signal is then re-transmitted by the satellite, and collected by various pieces of equipment, such as for example fixed satcom terminals 106 or mobile satcom terminals 107 that are for example located on-board airborne or ground-based platforms.

In the downlink direction (i.e. to receive data via the BBU from the satellite), the RRH 103 receives analogue RF signals on a carrier frequency transmitted by the satellite 105, transposes them to baseband, then converts them into digital I/Q samples that are transmitted to the BBU 101. The BBU demodulates and decodes the samples in order to extract therefrom the useful binary information that they transport. This useful information is either exploited by the BBU, or transmitted to a third-party piece of equipment through the network 102, for example in the form of IP datagrams.

So as to allow for problems with transmission availability, which may occur because of degradation of the link between the BBU and the RRH, a malfunction of the RRH and/or degradation of the link between the RRH and the satellite 105 as a result, for example, of unfavourable meteorological conditions, the RRH may be supplemented by RRH 111 and 113 connected to satcom antennas 112 and 114, respectively. The sites of the RRH may be very far apart, so as to benefit from different meteorological conditions. This redundancy makes it possible to change RRH when the link from one thereof fails.

In prior-art satcom networks, changes in RRH are made manually by an operator, in response for example to a deterioration in the meteorological conditions of the active RRH, or automatically by the BBU when it is informed that the transmission in course has not completed correctly. However, when problems with transmission of data between BBU and RRH occur, the response time of the control loop is at least about several tens of milliseconds or even far longer, and during this time I/Q samples that are not correctly routed will be lost.

The solutions of the prior art are therefore unsuitable for communications that require transmission latency to be limited and a high data integrity in case of malfunction of a piece of RRH equipment. The aim of the invention is to provide a solution that addresses this problem. This solution is for example applicable to satellite communications for security applications when the loss of information during transmission may have major consequences on the mission in which communication is the medium, as is for example the case when monitoring and controlling drones 107. The solution is also applicable to satellite communications for mass-market applications in which the limitation of latency is important, as is the case with the satellite access networks of telecommunication operators (in particular, the latency experienced on the satellite link may have a direct impact on the throughput observed by users, because of the particular operating modes of the network protocols, such as in particular TCP/IP, implemented end-to-end). In view of future developments, and especially the commissioning of very-high-throughput telecommunication-satellite systems and constellations (VHTS systems), ground segments are being required to move toward a necessarily higher number of gateways on account of the need to reuse the radio resource for the link between gateways and satellites. This implies a significant increase in the number of BBU/RRH, and a need for high-performance and reconfigurability on the links between these pieces of equipment. The invention allows the impact in terms of cost and of service of the aspects of redundancy and of tolerance to malfunctions of all the systems to be decreased.

The article by Vinnakota Venu Balaji et al., “An experimental study of C-RAN fronthaul workload characteristics: protocol choice and impact on network performances”, IEEE 89^{th} vehicular technology conference, 28 Apr. 2019 describes a device in which a RRH and a BBU exchange packets of I/Q samples according to the TCP network protocol. This solution is however problematic because, in TCP, the increased reliability achieved through retransmission cannot be dissociated from congestion control, i.e. regulation of throughput in order not to saturate the resources of the network. By nature, TCP throughput continuously varies and the associated end-to-end delay also varies, this being unacceptable when it is necessary to have a stable throughput and a stable latency (which is for example the case with satellite links).

The invention is also applicable to any RF communication carried out on the basis of digital information that leads to the generation of I/Q digital signal samples conveyed to one or more pieces of equipment that are potentially remote from one another and that are dedicated to the transmission thereof in the form of an over-the-air RF signal, as is for example the case with fifth-generation (5G) cellular mobile networks. Specifically, here too, the mass deployment of the equipment required by fifth-generation cellular mobile networks has resulted in the need to implement flexible and integrated communication methods to ensure the transmissions between BBU and RRH.

Various transmission protocols have been developed by the constructors of mobile networks with a view to organizing and standardizing the transmission of data over the digital communication link connecting the BBU to the one or more RRH. The most well-known are the protocols CPRI (standing for Common Public Radio Interface), eCPRI (standing for enhanced CPRI), OBSAI (standing for Open Base Station Architecture Initiative) and NGFI (standing for Next Generation Fronthaul Interface) Depending on the protocol, different designations may be used for the equipment (e.g., in the eCPRI protocol, the BBU are designated by the acronym REC (standing for Radio Equipment Control) and the RRH are designated RE (standing for Radio Equipment). These protocols do not however provide a solution to the problems of loss of packets and of retransmission latency, which are encountered when the data link between BBU and RRH has partially or completely failed.

### SUMMARY OF THE INVENTION

One aim of the invention is therefore to provide a method allowing the downtime of the data-transmission service to be minimized when the link between the equipment tasked with generating the I/Q samples in baseband and the equipment tasked with transmitting the corresponding signal over the air fails.

To this end, the present invention describes a method for transmitting data in a radiofrequency communication system, comprising:
at least one piece of equipment, referred to as the BBU, comprising a memory, this piece of equipment being configured to generate in-phase and quadrature digital samples, referred to as I/Q samples, from data to be sent, and to extract a payload from I/Q samples,
a plurality of pieces of equipment, referred to as RRH, comprising a memory, these pieces of equipment being configured to generate and transmit an RF analogue signal on the basis of I/Q samples, and to generate I/Q samples from a received RF analogue signal,
digital communication links for transmitting IQ samples between the one or more BBU and the RRH.

In the method according to the invention, each BBU is configured to transmit data in the telecommunication network through one of the RRH and to receive data of the telecommunication network from one of the RRH. The method has the particularity that the one or more BBU and the RRH are configured to exchange I/Q samples organized in the form of packets of I/Q samples marked by a sequence identifier, and to implement a mechanism for acknowledgement of the packets of I/Q samples that they exchange. The RRH that is the intended recipient of the packets of I/Q samples sent by each BBU is modified depending on the state of the acknowledgements of the packets of I/Q samples.

Advantageously, BBU and RRH are configured to protect the packets of I/Q samples that they exchange with an error correction code.

According to one embodiment of the invention, the transmission of data in the telecommunication network comprises:
a first step in which a BBU stores in memory and transmits one or more packets of I/Q samples corresponding to the data to be sent to a first RRH,
a second step in which the first RRH sends an acknowledgement of reception of the one or more packets of I/Q samples to the BBU via at least one acknowledgement mechanism among a positive acknowledgement mechanism and a negative acknowledgement mechanism,
a third step in which the first RRH generates and sends an RF analogue signal corresponding to the packets of I/Q samples correctly received,
a fourth step in which the BBU removes from its memory or resends the one or more packets of I/Q samples transmitted in the first step of the method depending on the acknowledgements received from the RRH following the second step of the method.

When the implemented acknowledgement mechanism comprises a positive acknowledgement mechanism:
the second step comprises the transmission, by the first RRH to the BBU, of an acknowledgement message ACK on correct reception of one or more packets of I/Q samples, the acknowledgement message comprising the sequence identifier of the one or more packets of I/Q samples,
the fourth step comprises the removal, by the BBU, of the packets of I/Q samples stored in memory that correspond to received acknowledgement messages ACK, and the retransmission of those packets of I/Q samples stored in memory for which no acknowledgement message ACK has been received by a given time;

When the implemented acknowledgement mechanism comprises a negative acknowledgement mechanism:
the second step comprises the transmission, by the first RRH to the BBU, of a negative acknowledgement message NACK when a packet of I/Q samples is erroneous or missing, the negative acknowledgement message NACK comprising the sequence identifier of the packet of I/Q samples,
the fourth step comprises the removal, by the BBU, of those packets of I/Q samples stored in memory for which no negative acknowledgement message NACK has been received by a given time, and the retransmission of those packets of I/Q samples for which a negative acknowledgement message NACK has been received.

Advantageously, when the number of packets not acknowledged or the number of packets negatively acknowledged in the fourth step is higher than a threshold in a given period, the retransmission of a packet of I/Q samples and the subsequent transmissions are carried out by a second RRH.

According to one embodiment of the invention, the reception of data in the communication network comprises:
a first step in which a RRH receiving a RF analogue signal generates, stores in memory and transmits to a BBU one or more corresponding packets of I/Q samples,
a second step in which the BBU sends an acknowledgement of reception of the one or more packets of I/Q samples to the RRH via at least one acknowledgement mechanism among a positive acknowledgement mechanism and a negative acknowledgement mechanism,
a third step in which the BBU extracts data from the packets of I/Q samples correctly received,
a fourth step in which the RRH removes from its memory or resends the one or more packets of I/Q samples transmitted in the first step of the method depending on the acknowledgements received from the BBU following the second step of the method.

When the implemented acknowledgement mechanism comprises a positive acknowledgement mechanism:
the second step comprises the transmission, by the BBU to the RRH, of an acknowledgement message ACK on correct reception of one or more packets of I/Q samples, the acknowledgement message comprising the sequence identifier of the one or more packets of I/Q samples,
the fourth step comprises the removal, by the RRH, of the packets of I/Q samples stored in memory that correspond to received acknowledgement messages ACK, and the retransmission of those packets of I/Q samples stored in memory for which no acknowledgement message ACK has been received by a given time.

When the implemented acknowledgement mechanism comprises a negative acknowledgement mechanism:
the second step comprises the transmission, by the BBU to the RRH, of a negative acknowledgement message NACK when a packet of I/Q samples is erroneous or missing, the negative acknowledgement message NACK comprising the sequence identifier of the packet of I/Q samples,
the fourth step comprises the removal, by the RRH, of those packets of I/Q samples stored in memory for which no negative acknowledgement message NACK has been received by a given time, and the retransmission of those packets of I/Q samples for which a negative acknowledgement message NACK has been received.

Advantageously, in the fourth step, the retransmission of a packet of I/Q samples is carried out via another digital communication link.

According to one embodiment, the RF communication system furthermore comprises a piece of equipment for supervising the BBU and RRH, the supervising equipment being configured to associate RRH and BBU for the transmission of data. Advantageously, the supervising equipment supervises the queues of the one or more BBU and of the RRH.

According to one embodiment, the digital communication link for the transmission of the packets of I/Q samples between BBU and RRH uses a communication protocol among the standards CPRI, eCPRI, OBSAI and NGFI. Advantageously, the communication protocol used is the eCPRI protocol the “eCPRI Message Type” field of which is used to identify the packets of I/Q samples.

According to one embodiment, the digital communication links between BBU and RRH or between RRH and BBU are of constant throughput.

The invention also relates to a radiofrequency communication system comprising:
at least one piece of equipment, referred to as the BBU, comprising a memory, this piece of equipment being configured to generate in-phase and quadrature digital samples, referred to as I/Q samples, from data to be sent, and to reconstruct received data from I/Q samples,
a plurality of pieces of equipment, referred to as RRH, comprising a memory, these pieces of equipment being configured to generate and transmit an RF analogue signal on the basis of I/Q samples, and to generate I/Q samples from a received RF analogue signal,
digital communication links for transmitting IQ samples between the one or more BBU and the RRH.

In the RF communication system according to the invention, each BBU is configured to transmit data in the telecommunication network through one of the RRH and to receive data of the telecommunication network from one of the RRH. The method has the particularity that the one or more BBU and the RRH are configured to exchange I/Q samples organized in the form of packets of I/Q samples marked by a sequence identifier, and to implement a mechanism for acknowledgement of the packets that they exchange. The RRH that is the intended recipient of the packets of I/Q samples sent by each BBU is modified depending on the state of the acknowledgements of the packets of I/Q samples.

Lastly, the invention relates to a device comprising a memory, which device is configured to operate as a BBU or RRH in a communication system according to the invention.

### BRIEF DESCRIPTION OF THE DRAWINGS

The invention will be better understood and other features, details and advantages will become more clearly apparent on reading the following non-limiting description, and by virtue of the appended figures, which are given by way of example.

FIG. 1 by way of example illustrates the principle of generation and transmission of an RF signal in a satellite communication network according to the prior art.

FIG. 2 shows a communication system in which the method for transmitting data according to one embodiment of the invention may be implemented.

FIG. 3 shows the various steps of a method for transmitting data according to one embodiment of the invention, in the uplink direction.

FIG. 4 schematically shows one implementation of the method for transmitting data between BBU and RRH according to one embodiment of the invention.

FIG. 5 shows the various steps of a method for transmitting data according to one embodiment of the invention, in the downlink direction.

FIG. 6 shows one embodiment of a communication system in which the method for transmitting data according to one embodiment of the invention may be implemented.

FIG. 7 illustrates various portions of data packets using the eCPRI protocol, which portions may be used to identify packets of I/Q samples transmitted between BBU and RRH.

Identical references have been used in the various figures when they designate identical or comparable elements.

### DETAILED DESCRIPTION

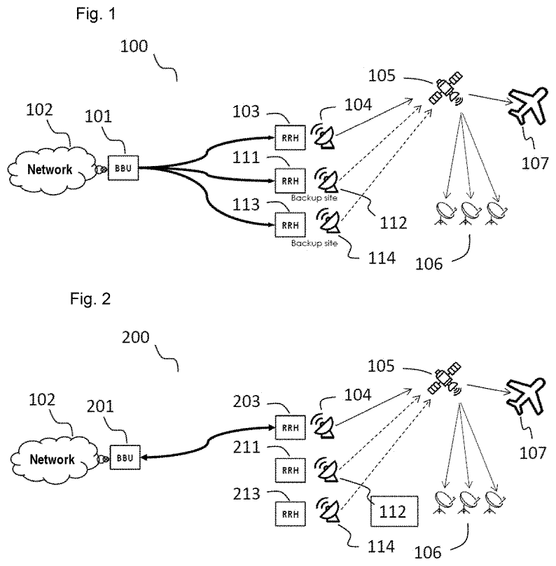

FIG. 2 shows a communication system in which the method for transmitting data according to one embodiment of the invention may be implemented in the uplink direction.

The method for transmitting data according to the invention is shown and described here in the context of a satellite communication network, such as that shown in FIG. 2, but it is applicable to any RF communication network in which the equipment in which the I/Q digital samples to be transmitted are generated and the equipment that actually transmits them in the form of an RF signal are different.

The communication system 200 comprises:
at least one piece of equipment, referred to as the BBU 201, comprising a memory, tasked with generating in-phase and quadrature digital samples, referred to as I/Q samples, from data to be sent, and with extracting a payload from a sequence of I/Q samples,
at least two pieces of equipment each comprising one memory, which are referred to as RRH 203, 211 and 213, tasked with generating a radiofrequency analogue signal on the basis of I/Q samples received from a BBU then with transmitting it and vice versa, and
digital communication links for transmitting I/Q samples between the one or more BBU and the RRH, for example an ethernet network, an IP network or a dedicated communication link such as a fibre-optic link. The BBU are not necessarily connected to all the RRH, and vice versa.

To increase their reliability, each piece of equipment may be locally redundant.

An “active” RRH is associated with each BBU, which RRH is the RRH used to send the data of the BBU or to receive the RF signals from which the BBU extracts the payload. To this end, the BBU generally have a list of RRH associated with an order of preference that is established beforehand operationally with respect to various considerations such as the proximity of the RRH, the cost of use of the RRH, etc. On the basis of this order of preference that is established beforehand, the BBU chooses the active RRH depending on criteria that are known in real-time, such as for example the actual availability of terrestrial links and/or meteorological data specific to each geographical region in which each RRH is installed, in order to anticipate the availability and/or the accessible throughput of the satellite RF links.

In the uplink direction, the BBU 201 is configured to convert the flows of digital data to be transmitted into the form of data quantifying the amplitude of the signal on the in-phase and quadrature channels (I/Q samples) It comprises computing means and a memory that is configured to store the generated packets of I/Q samples or the IP or ethernet data packets comprising these packets of I/Q samples. Furthermore, a plurality of BBU may be implemented in parallel in the same system.

The RRH 202, 203 and 211 comprises a radiofrequency chain configured, on the basis of digital I/Q samples in baseband, to produce and to send over the air an analogue RF signal at a carrier frequency. The RRH therefore comprises at least a digital-to-analogue converter, a frequency-converting function, and a power amplifier.

The invention consists of a method for organizing the transmissions between BBU and RRH giving an active role to the RRH, contrary to the communication systems of the prior art. To do so, the BBU organizes the I/Q samples to be sent in the form of packets of I/Q samples associated with a sequence identifier. The packets of I/Q samples are prepared so as to be able to be converted directly into an analogue RF signal, i.e. the I/Q samples comprise, in addition to the useful information to be transmitted, all the required signalling information (pilot sequences, prefixes if necessary, etc. etc.), and form an integer number of symbols to be sent. These packets of I/Q samples are stored and encapsulated in network data packets.

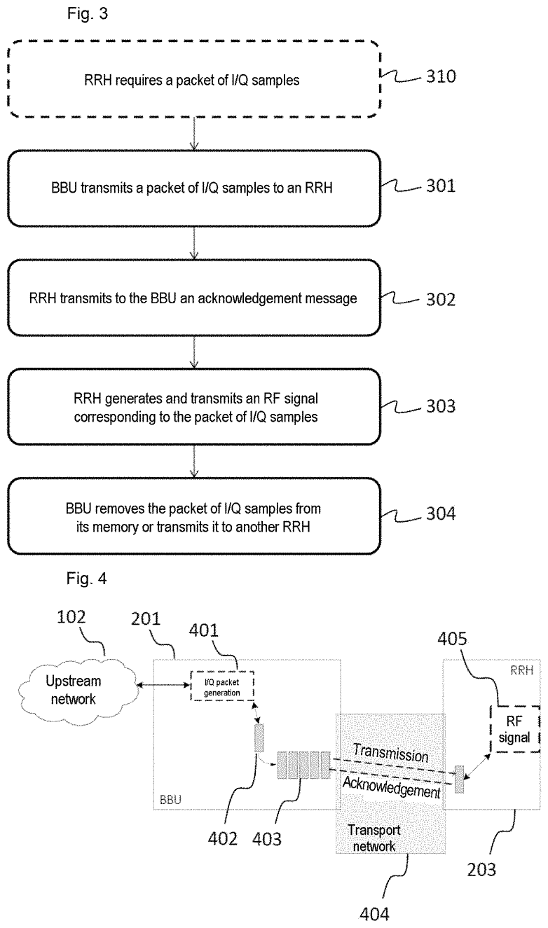

FIG. 3 shows the various steps of a method for transmitting data according to one embodiment of the invention, in the uplink direction.

It comprises a first step 301, in which the BBU sends to the active RRH at least one packet of I/Q samples, each packet of samples being associated with one sequence identifier. Advantageously, the sequence identifiers are deterministic, this for example being achieved using an incremental identifier, in order to allow the RRH to detect packet losses on the basis of the received sequences of identifiers. As detailed below, lost packets are re-transmitted, and keep in this case their initial sequence identifier.

Alternatively, the first step 301 of the method may be preceded by a preliminary step 310 in which the BBU discloses its queue to the RRH for example via a backhaul network. When the BBU has data to be sent, the active RRH sees it in the queue, and transmits a request to transmit I/Q samples to which the BBU responds with the packets of I/Q samples. This step allows the BBU to ensure that the data link with the RRH and the RRH itself are operational before transmitting the data.

The transmitting method according to one embodiment of the invention comprises a second step 302, in which the RRH acknowledges the data packets. According to one embodiment, the implemented acknowledgement mechanism may be a positive acknowledgement mechanism, in which the RRH transmits to the BBU an acknowledgement message ACK as soon as a packet of I/Q samples has been correctly received, the acknowledgement message ACK comprising the sequence identifier associated with the received packet of I/Q samples. Alternatively, the implemented acknowledgement mechanism may be a negative acknowledgement mechanism in which a negative acknowledgement message NACK is transmitted on detection of an erroneous or missing packet of I/Q samples, a missing packet being able to be detected by tracking the progression of the deterministic identifiers of the received packets of I/Q samples, or when a packet of which the retransmission is expected has not been received by a given time, or in case of failure of the radio chain of the RRH. The identifier of the one or more erroneous or missing packets are transmitted in the message NACK.

The implementation of a negative acknowledgement mechanism is more efficient than the implementation of a positive acknowledgement given the amount of data exchanged and the response time, but does not allow any degradation of the communication link between BBU and RRH to be detected, unlike the positive acknowledgement does. The two mechanisms may be implemented together.

Advantageously, the (positive and/or negative) acknowledgement messages may be grouped together so as to acknowledge a plurality of packets of I/Q samples at a time, this allowing the exchanges between RRH and BBU to be limited (approach of the Selective ACKnowledgement (SACK) type).

The transmitting method according to one embodiment of the invention comprises a third step 303, in which the RRH generates the analogue RF signal corresponding to the packets of I/Q samples correctly received, and transmits it over the air to the satellite (or the user terminal).

The transmitting method according to one embodiment of the invention lastly comprises a fourth step 304, in which the BBU removes from its memory or retransmits the packets of I/Q samples transmitted in the first step of the method depending on the received acknowledgements.

This step depends on the implemented acknowledgement mechanism. When it is a question of a positive acknowledgement mechanism:
the BBU receiving an acknowledgement message ACK informing it of correct reception of a packet of I/Q samples by the RRH, it removes from its memory the packet of I/Q samples in question, by virtue of the sequence identifier comprised in the acknowledgement message,
when it has not received an acknowledgement message from the RRH informing it of the correct reception of a packet of I/Q samples by a given time, the BBU reiterates the transmission of the packet of I/Q samples in question.

When it is a question of a negative acknowledgement mechanism:
the BBU receiving an acknowledgement message informing it of erroneous or missing reception of a packet of I/Q samples by the RRH, it re-transmits the packet of I/Q samples in question, by virtue of the sequence identifier comprised in the acknowledgement message,
the BBU having not received a message informing it of erroneous or missing reception of a packet of I/Q samples by the RRH by a given time, removes the packets of I/Q samples in question from its memory.

The mechanism for acknowledgement of messages implemented in the second step and in the fourth step of the method makes it possible to ensure:
that the message is sent by the BBU has indeed been received by the RRH, and that there is therefore no degradation of or error in the link between these two pieces of equipment, and
in the case of a positive acknowledgement mechanism, that the RRH is operational, the acknowledgement message ACK playing in this case the role of an implicit request to transmit new packets of I/Q samples.

The order in which steps 302, 303 and 304 are executed is not fixed. These steps make it possible to avoid losses of packets and to limit the latency of message retransmission, and therefore the downtime of the link, contrary to known prior-art transmitting methods in which the I/Q samples are transmitted without an acknowledgement mechanism.

The length of time after which, if no acknowledgement message has been received, a packet of I/Q samples is re-transmitted (positive acknowledgement) or the packet of I/Q samples is removed from the memory of the BBU (negative acknowledgement) is defined depending on the operational context: too short, it may be a source of unnecessary retransmission of packets of I/Q samples or of an inability to re-transmit packets; too long, it increases the latency of retransmission of the packets or the required memory space. Following absence of reception of an acknowledgement message ACK, on reception of a negative reception message NACK, or when the number of packets not acknowledged or negatively acknowledged is higher than a threshold in a given period, the BBU may switch all of its subsequent transmissions (including the retransmission of packets) to a second RRH, this allowing the continuity of the link to be guaranteed while leaving open the possibility of diagnosing the failed RRH, and optionally returning to the first RRH once the link has once again become operational.

The positive acknowledgement of packets of samples and the transmission of the following packets of samples may be carried out using a “stop and wait” technique, in which the BBU transmits a packet of I/Q samples to the RRH and waits for the acknowledgement ACK of this packet before transmitting a new one, or via a “go back N” technique, in which the BBU transmits N consecutive packets of I/Q samples to the RRH, which acknowledges each of the packets individually or acknowledges all of the N packets with a single message. The use of the “go back N” technique to acknowledge a plurality of messages uses the data link between RRH and BBU more efficiently. The principle is the same for negative acknowledgement mechanisms, in which a plurality of packets may be acknowledged with the same message NACK. More generally, the invention is applicable whatever the ARQ mechanism (ARQ standing for Automatic Repeat reQuest) implemented.

Advantageously, the invention is applicable in the case of a so-called “hybrid ARQ” mechanism combining FEC (standing for Forward Error Correction) and retransmission. This method consists in protecting the packets of I/Q samples with an additional layer of error correction code, in order to correct certain erroneous packets on reception thereof, with the aim of decreasing latency consecutive to the retransmissions in the case of loss of packets. In this case, the first step 301 is modified in that the BBU computes, for each series of M packets to be sent, a series of N redundant packets, M and N being design choices that are made by the operator depending on the level of protection judged necessary given what is known of the type of network and of the type of link connecting the BBU and the RRH. The N redundant packets are sent by the BBU after the M data packets, referred to as payload. Just like the useful packets, the redundant packets must possess a sequence identifier. Many error-correction-code algorithms allowing the sought-after effect to be obtained are well known to those skilled in the art—for example, block error-correction codes, such as Reed-Solomon codes, or convolutional codes. On reception of the packets by the RRH, the series of useful and redundant packets is reconstructed, taking into account the positions if any of lost packets by virtue of the sequence identifiers of the other received packets. If there are no lost packets in the first M packets of the series (useful packets), the RRH may remove the redundant packets. If packets have been lost, the RRH will attempt to decode the series of packets with a view to reconstructing the series of M useful packets. If it succeeds in doing so, the I/Q samples may be extracted directly. The RRH then sends an acknowledgement of the data packets to the BBU, via a positive acknowledgement message ACK when this is the acknowledgement mechanism implemented. In the contrary case, one or more negative acknowledgement messages NACK are sent in order to request retransmission of the missing packets by the BBU when this is the acknowledgement mechanism implemented.

The described transmitting method therefore allows a complete breakdown of the data link between BBU and RRH to be very rapidly detected, and action to be immediately taken to switch to a substitute RRH without loss of packets.

It furthermore allows the BBU to switch to a substitute RRH without loss of packets, and in particular of packets in the process of being acknowledged by the first RRH, in case of a very rapid degradation in the quality of the link (for example in the case of poor meteorological conditions or of interference created by another emission source).

FIG. 4 schematically shows the implementation of the method for transmitting between BBU and RRH according to one embodiment of the invention, which embodiment is given by way of example, and in which the implemented acknowledgement mechanism is a positive packet-acknowledgement mechanism.

The BBU 201 has data to be sent, which are generated locally or received through an upstream network 102. These data are converted into packets of I/Q samples, then into network data packets to be transmitted via the computing means 401, such as a processor for example, a digital signal processor (DSP), or a specialized circuit such as an ASIC (application-specific integrated circuit) or an FPGA (field-programmable gate array). Identifiers are associated with the packets of I/Q samples.

The generated packets 402 of I/Q samples are stacked in a memory 403, for example a memory of FIFO type (FIFO standing for first-in first-out) or any other type of memory. The oldest packet of I/Q samples is transmitted to the RRH 203 through a transport network 404, which may for example be a dedicated link provided by an IP or ethernet network, or a dedicated fibre-optic link. Following reception of the packet of I/Q samples, an acknowledgement message ACK is transmitted by the RRH to the BBU, which may then remove the packet of samples in question from its memory 403. When the acknowledgement message has not been received by the BBU by a given time (or when the RRH transmits thereto a negative acknowledgement message NACK), the packet of I/Q samples is retransmitted, advantageously to another RRH. The RRH converts the packets of I/Q samples that have been correctly received into RF analogue signals 405 and transmits them over the air (for example to a repeater satellite).

On the downlink, the inverse method is applied in a substantially equivalent manner. In this case, the RRH 202, 211 and 203 comprises an analogue-to-digital converter and a radiofrequency chain that is configured to produce digital I/Q samples in baseband from an analogue RF signal at a carrier frequency. It is also configured to convert the I/Q samples into the form of packets of samples associated with an identifier, and to store them in memory.

The BBU 201 receives the packets of I/Q samples transmitted by the RRH, and is configured to extract therefrom a flow of digital information by demodulating them and decoding them.

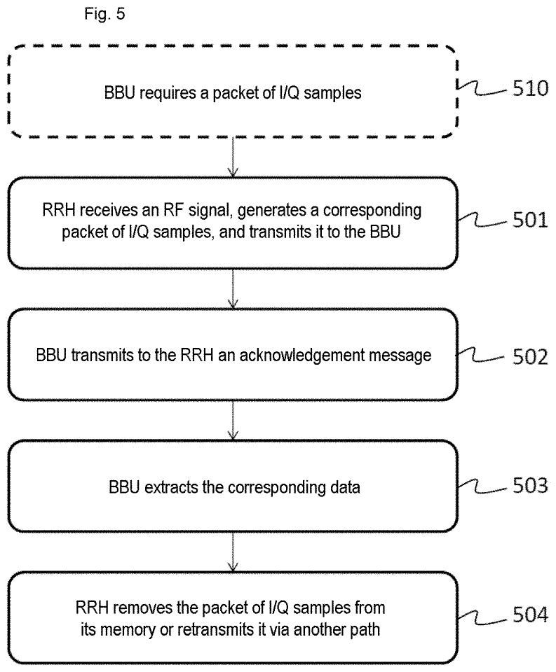

FIG. 5 shows the various steps of a method for transmitting data according to one embodiment of the invention, in the downlink direction. It comprises:
a first step 501, in which the RRH receives an analogue RF signal from over the air, and is configured to extract therefrom one or more corresponding packets of I/Q samples, each comprising one sequence identifier, advantageously a deterministic identifier, that it stores in memory and sends to the BBU,
a second step 502 in which the BBU acknowledges the data packets, either via a positive acknowledgement mechanism in which an acknowledgement message ACK is transmitted to the RRH when a packet of I/Q samples has been correctly received, or via a negative acknowledgement mechanism in which an acknowledgement message NACK is transmitted to the RRH when a packet of samples is detected as being erroneous or missing, or via a combination of both mechanisms,
a third step 503 in which the BBU extracts the received payload by carrying out all of the necessary processing operations, and in particular demodulation and decoding, on the packets of digital I/Q samples,
a fourth step 504 in which the RRH removes from its memory or resends the packets of I/Q samples transmitted in the first step of the method depending on the received acknowledgement messages:
   when it receives an acknowledgement message ACK informing it of correct reception of a packet of I/Q samples or when no negative acknowledgement message NACK has been received by a given time, the RRH removes from its memory the corresponding packet of I/Q samples by virtue of its sequence identifier,
   when it has not received an acknowledgement message ACK informing it of correct reception of a packet of I/Q samples by a given time or when it receives a negative acknowledgement message NACK informing it that a packet of I/Q samples has not been correctly received or is missing, the RRH retransmits the corresponding packet of I/Q samples to the BBU.

Advantageously, in the fourth step 504, when a packet of I/Q samples is retransmitted, it may be rerouted via another communication link: ideally via another physical link, such as for example a redundant communication link between RRH and BBU and/or a different network path in a switched IP network. Subsequent transmissions may also be carried out using the redundant communication link/the different network path. The order in which steps 502, 503 and 504 are executed is not fixed.

Alternatively or in addition, when the network comprises a plurality of BBU, the RRH may be configured to retransmit the packets of samples and the subsequent transmissions to another BBU.

Just as with the uplink, in step 501, the RRH may send to the BBU packets of I/Q samples as soon as they are ready, or disclose its queue to the BBU and wait for a request sent by the BBU in a preliminary step 510.

Just as with the uplink, the invention is applicable in the case of a so-called “hybrid ARQ” mechanism in which forward error correction (FEC), via the addition of a layer of error correction code to the transmitted data packets, and retransmissions are combined.

Finally, just as with the uplink, messages may be acknowledged in various ways, such as for example via a “stop and wait” or “go back N” mechanism in which the acknowledgement messages are grouped together.

The method according to the invention has the same advantages in the uplink direction and in the downlink direction. In particular, the implementation of a mechanism for acknowledging exchanges between RRH and BBU makes it possible to ensure that there is no degradation of the communication link between these two pieces of equipment and that BBU is indeed operational. It furthermore makes it possible to avoid loss of packets, and to afford a low message-retransmission latency.

Contrary to network protocols such as the TCP protocol, the method according to the invention does not implement a congestion-control mechanism. The BBU and the RRH are configured to transmit the packets of I/Q samples with a constant throughput.

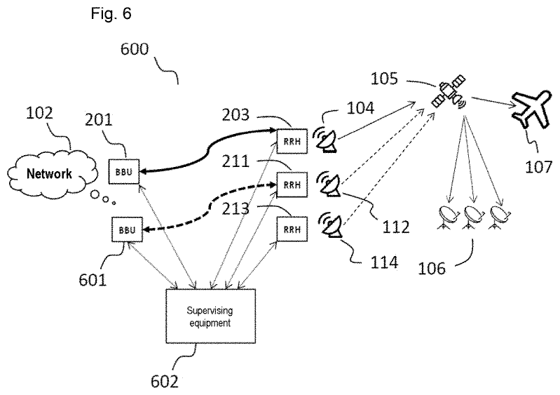

FIG. 6 shows another embodiment of the invention, in which embodiment the communication system 600 furthermore comprises a second BBU 601 and a piece of equipment 602 for supervising the BBU and the RRH.

The supervising equipment is configured to determine the transmission requirements of the BBU and their state. To this end, it supervises the queues of the packets of I/Q samples to be transmitted by the BBU, for example via regular exchanges of control messages in a backhaul network.

Likewise, the supervising equipment is configured to determine the state of the queues of the RRH and of the equipment.

The supervising equipment 602 associates one BBU with one RRH when a BBU (uplink) or a RRH (downlink) needs to transmit. This association may be carried out according to orders of preference established operationally with respect to various considerations such as the actual availability of terrestrial links, known meteorological data specific to the geographic region in which each RRH is installed, the proximity of the RRH and the BBU, the cost of use of the RRH, etc.

The supervising equipment is also configured to review the associations between BBU and RRH when this is justified, i.e.:
when a RRH or a BBU becomes unreachable, and/or
when the queue of a BBU or of a RRH is filled beyond a threshold, the value of the threshold possibly being chosen to be slightly higher than the maximum number of packets of samples that are in the process of being acknowledged in nominal operation. This number may be relatively high given the targeted throughputs, but it however allows an upper limit to be set for the time of initiation of a change in BBU/RRH association consecutively to a disruption of the link.

Otherwise, the packets of I/Q samples and the acknowledgements between BBU and RRH are transmitted as described with reference to FIGS. 3 and 5. In particular, the supervising equipment monitors the packet acknowledgements, and modifies the associations between BBU and RRH when it is necessary.

The supervising equipment therefore allows the process of associating BBU and RRH and the process of switching the equipment to be automated. The switches occur dynamically and transparently, without the intervention of an operator.

The transmitting methods according to the invention are in particular based on marking data packets with a sequence identifier, this allowing the memory space required to store them to be optimally managed and allowing them to be retransmitted if necessary.

The protocols conventionally used for transmissions between BBU and RRH, such as for example the protocols CPRI, eCPRI, OBSAI and NGFI, allow data to be transmitted in packets over ethernet or IP/UDP links, but make no provision to identify the transmitted data packets. They therefore do not allow the transmitting method according to the invention to be implemented without adjustments. It is therefore necessary to adapt the use thereof in order to make them compatible with the described method.

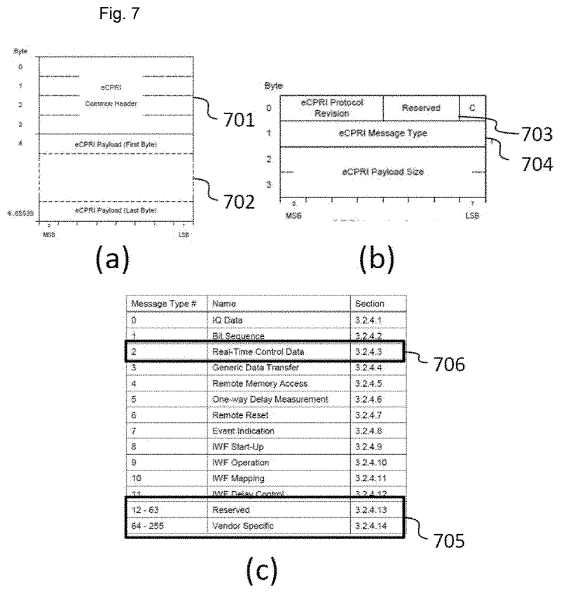

FIG. 7 illustrates (in (a), (b) and (c)) various fields of data packets according to the eCPRI protocol, which fields may be used to identify packets of I/Q samples.

As shown in (a), the data packets eCPRI comprise a header 701 (eCPRI common Header) and a payload 702 (eCPRI Payload).

Table (b) shows the various fields of the header 701. Among these fields, the “reserved” field 703 (Reserved) comprises three bits allowing provision of a first numbering level for identifying the sequences. However, three bits are generally not enough to number the packets of I/Q samples to be transmitted on account of the throughputs in question. The eCPRI header also comprises a field at 704 of one byte regarding the type of message (eCPRI Message Type). The invention proposes to use this field to identify the packets of I/Q samples.

Table (c) shows the various types of messages able to be transmitted in the field 704 i.e. in the field eCPRI Message Type. The messages 12 to 255 referenced 705, i.e. 244 messages, may be used to identify the data packets. Lastly, the field 706 (Real-Time Control Data) may be used as an additional message to identify the packets.

The header of eCPRI data packets may therefore be used to number the packets of I/Q samples to be transmitted. The reserved field 703 allows 3 bits to be provided, in order to implement 8 concurrent flows. The field 705, i.e. the field eCPRI Message Type, allows a set of 244 messages to be defined per concurrent flux in order to identify the packets. The field 706, i.e. the field Real-Time Control Data, may be used for an additional message. Thus, by combining these three data, it is possible to define a set of 8*245=1960 messages, or 245 messages per flow for 8 concurrent flows, this allowing the needs of a plurality of parallel flows and of flows of very high throughputs to be met.

The method for transmitting data according to the invention may then be implemented using standard transmission protocols between BBU and RRH, using the fields of the data-packet headers to number the packets. It does not necessarily require the standards to be modified since existing fields may be diverted for the targeted ends.

The invention also relates to a communication system comprising one or more BBU and a plurality of RRH, the equipment being configured to implement one of the embodiments of the method described above. It also relates to the BBU and RRH equipment of this communication system, this equipment being configured to exchange I/Q samples that are transmitted in packets and associated with an acknowledgement and retransmission mechanism.

1. A method for transmitting data in a radiofrequency (RF) communication system, comprising:
at least one piece of equipment, referred to as the BBU, comprising a memory, this piece of equipment being configured to generate in-phase and quadrature digital samples, referred to as I/Q samples, from data to be sent, and to extract a payload from I/Q samples,
a plurality of pieces of equipment, referred to as RRH, comprising a memory, these pieces of equipment being configured to generate and transmit an RF analogue signal on the basis of I/Q samples, and to generate I/Q samples from a received RF analogue signal,
digital communication links for transmitting IQ samples between the one or more BBU and the RRH,
each BBU being configured to transmit data in the telecommunication network through one of the RRH and to receive data of the telecommunication network from one of the RRH, the transmitting method being wherein the one or more BBU and the RRH are configured to exchange I/Q samples organized in the form of packets of I/Q samples marked by a sequence identifier, and to implement a mechanism for acknowledgement of the packets of I/Q samples that they exchange, and in that the RRH that is the intended recipient of the packets of I/Q samples sent by each BBU is modified depending on the state of the acknowledgements of the packets of I/Q samples.

2. The method for transmitting data according to claim 1, wherein BBU and RRH are configured to protect the packets of I/Q samples that they exchange with an error correction code.

3. The method for transmitting data according to claim 1, wherein the transmission of data in the telecommunication network comprises:
a first step wherein a BBU stores in memory and transmits one or more packets of I/Q samples corresponding to the data to be sent to a first RRH,
a second step wherein the first RRH sends an acknowledgement of reception of the one or more packets of I/Q samples to the BBU via at least one acknowledgement mechanism among a positive acknowledgement mechanism and a negative acknowledgement mechanism,
a third step wherein the first RRH generates and sends an RF analogue signal corresponding to the packets of I/Q samples correctly received,
a fourth step wherein the BBU removes from its memory or resends the one or more packets of I/Q samples transmitted in the first step of the method depending on the acknowledgements received from the RRH following the second step of the method.

4. The method for transmitting data according to claim 1, wherein, when the implemented acknowledgement mechanism comprises a positive acknowledgement mechanism:
the second step comprises the transmission, by the first RRH to the BBU, of an acknowledgement message ACK on correct reception of one or more packets of I/Q samples, the acknowledgement message comprising the sequence identifier of the one or more packets of I/Q samples,
the fourth step comprises the removal, by the BBU, of the packets of I/Q samples stored in memory that correspond to received acknowledgement messages ACK, and the retransmission of those packets of I/Q samples stored in memory for which no acknowledgement message ACK has been received by a given time;
and wherein, when the implemented acknowledgement mechanism comprises a negative acknowledgement mechanism:
the second step comprises the transmission, by the first RRH to the BBU, of a negative acknowledgement message NACK when a packet of I/Q samples is erroneous or missing, the negative acknowledgement message NACK comprising the sequence identifier of the packet of I/Q samples,
the fourth step comprises the removal, by the BBU, of those packets of I/Q samples stored in memory for which no negative acknowledgement message NACK has been received by a given time, and the retransmission of those packets of I/Q samples for which a negative acknowledgement message NACK has been received.

5. The method for transmitting data according to claim 3, wherein, when the number of packets not acknowledged or the number of packets negatively acknowledged in the fourth step is higher than a threshold in a given period, the retransmission of a packet of I/Q samples and the subsequent transmissions are carried out by a second RRH.

6. The method for transmitting data according to claim 1, wherein the reception of data in the communication network comprises:
a first step wherein a RRH receiving a RF analogue signal, generates stores in memory and transmits to a BBU one or more corresponding packets of I/Q samples,
a second step wherein the BBU sends an acknowledgement of reception of the one or more packets of I/Q samples to the RRH via at least one acknowledgement mechanism among a positive acknowledgement mechanism and a negative acknowledgement mechanism,
a third step wherein the BBU extracts data from the packets of I/Q samples correctly received,
a fourth step wherein the RRH removes from its memory or resends the one or more packets of I/Q samples transmitted in the first step of the method depending on the acknowledgements received from the BBU following the second step of the method.

7. The method for transmitting data according to claim 1, wherein, when the implemented acknowledgement mechanism comprises a positive acknowledgement mechanism:
the second step comprises the transmission, by the BBU to the RRH, of an acknowledgement message ACK on correct reception of one or more packets of I/Q samples, the acknowledgement message comprising the sequence identifier of the one or more packets of I/Q samples,
the fourth step comprises the removal, by the RRH, of the packets of I/Q samples stored in memory that correspond to received acknowledgement messages ACK, and the retransmission of those packets of I/Q samples stored in memory for which no acknowledgement message ACK has been received by a given time;
and wherein, when the implemented acknowledgement mechanism comprises a negative acknowledgement mechanism:
the second step comprises the transmission, by the BBU to the RRH, of a negative acknowledgement message NACK when a packet of I/Q samples is erroneous or missing, the negative acknowledgement message NACK comprising the sequence identifier of the packet of I/Q samples,
the fourth step comprises the removal, by the RRH, of those packets of I/Q samples stored in memory for which no negative acknowledgement message NACK has been received by a given time, and the retransmission of those packets of I/Q samples for which a negative acknowledgement message NACK has been received.

8. The method for transmitting data according to claim 6, wherein, in the fourth step, the retransmission of a packet of I/Q samples is carried out via another digital communication link.

9. The method for transmitting data according to claim 1, wherein the RF communication system furthermore comprises a piece of equipment for supervising the BBU and RRH, the supervising equipment being configured to associate RRH and BBU for the transmission of data.

10. The method for transmitting data according to claim 9, wherein the supervising equipment supervises queues of the one or more BBU and of the RRH.

11. The method for transmitting data according to claim 1, wherein the digital communication link for the transmission of the packets of I/Q samples between BBU and RRH uses a communication protocol among the standards CPRI, eCPRI, OBSAI and NGFI.

12. The method for transmitting data according to claim 11, wherein the communication protocol used is the eCPRI protocol the “eCPRI Message Type” field of which is used to identify the packets of I/Q samples.

13. The method for transmitting data according to claim 1, wherein the digital communication links between BBU and RRH or between RRH and BBU are of constant throughput.

14. A radiofrequency (RF) communication system, comprising:
at least one piece of equipment, referred to as the BBU, comprising a memory, this piece of equipment being configured to generate in-phase and quadrature digital samples, referred to as I/Q samples, from data to be sent, and to reconstruct received data from I/Q samples,
a plurality of pieces of equipment, referred to as RRH, comprising a memory, these pieces of equipment being configured to generate and transmit an RF analogue signal on the basis of I/Q samples, and to generate I/Q samples from a received RF analogue signal,
digital communication links for transmitting IQ samples between the one or more BBU and the RRH,
each BBU being configured to transmit data in the telecommunication network through one of the RRH and to receive data of the telecommunication network from one of the RRH, wherein the one or more BBU and the RRH are configured to exchange I/Q samples organized in the form of packets of I/Q samples marked by a sequence identifier, and to implement a mechanism for acknowledgement of the packets that they exchange, and in that the RRH that is the intended recipient of the packets of I/Q samples sent by each BBU is modified depending on the state of the acknowledgements of the packets of I/Q samples.

15. A device comprising a memory, wherein it is configured to operate as a BBU or RRH in a communication system according to claim 14.
